(19) United States
(12) Patent Application Publication
(10) Pub. No.: US 2005/0256935 A1
(43) Pub. Date: Nov. 17, 2005

(54) System and method for managing a network

(76) Inventors: Matthew L. Overstreet, Richmond, VA (US); Richard A. Braun, Mechanicsville, VA (US); Thomas John Hayden, Glen Allen, VA (US)

Correspondence Address: BAKER & MCKENZIE LLP, 805 THIRD AVENUE - 29TH FLOOR, NEW YORK, NY, 10022, US

(21) Appl. No.: 10/840,161

(22) Filed: May 6, 2004

(51) Int. Cl. G06F 15/16

(52) U.S. Cl. 709/208

(57) ABSTRACT

A method for managing a network, the network comprising partitioning the network into at least one subnet, the at least one subnet including a plurality of clients, selecting one of the plurality of clients to be operable as a subnet controller, and selecting another of the plurality of clients to be operable as a successor subnet controller, the subnet controller and the successor subnet controller being operable for determining health of the plurality of clients within the at least one subnet.

### FIELD

The present application relates to computer system management, and more particularly, to a system and method for managing a network including at least one subnet.

### BACKGROUND

Managing large quantities of desktop computers is challenging. During times of network crisis, such as a virus infection or mass application outage, a common hindrance faced while trying to effectively manage the situation is timely information. Traditional inventory management systems collect much of this data, but can lag days or even weeks behind current conditions. Some industry experts estimated that one virus recently hit critical mass on the Internet twenty seven minutes after the virus was released.

Some companies have infrastructure in place to distribute security patches, virus definitions and collect inventory data, but such infrastructures are only as good as the controls in place for the respective platform. Specifically, these infrastructures can only manage computers that are in compliance with a respective company's corporate standards. Accordingly, a large gap results in the company's defenses, as vendors, contractors, employees and others may connect to the network with unmanaged computers.

Therefore, a need exist for a system and method that uses a client within a respective subnet of the network to monitor other clients within that subnet, for instance, to rapidly gather and report time-sensitive information about an end user platform across a large network.

### SUMMARY

An aspect of the present application provides for a method for managing a network, the network comprising partitioning the network into at least one subnet, the at least one subnet including a plurality of clients, selecting one of the plurality of clients to be operable as a subnet controller, and selecting another of the plurality of clients to be operable as a successor subnet controller, the subnet controller and the successor subnet controller being operable for determining health of the plurality of clients within the at least one subnet.

Another aspect of the present application provides for a method for managing a subnet having a plurality of clients, the method comprising operating as a subnet controller, the subnet controller being one of the plurality of clients, reporting to a global controller, receiving data from the global controller, transmitting data to the plurality of clients within the subnet, receiving feedback data from at least one client of the plurality of clients, evaluating the feedback data for determining health of the at least one client, and reporting to the global controller data regarding the health of the at least one client.

A further aspect of the present application provides for a system for managing a network including at least one subnet, the system comprising a plurality of clients located within the at least one subnet, one client of the plurality of clients operable as a subnet controller for managing the at least one subnet, each of the plurality of clients having an election algorithm for selecting the one client within each of the plurality of subnets operable as the subnet controller, and a global controller coupled to the at least one subnet, the global controller transmitting at least one health rule to the one client within each of the plurality of subnets operable as the subnet controller, wherein the one client within the at least one subnet operable as the subnet controller delegates to at least one of the other clients within the at least one subnet monitoring of the plurality of clients within the at least one subnet according to the at least one health rule.

### BRIEF DESCRIPTION OF THE DRAWINGS

FIG. 1 illustrates an exemplary network management system according to the exemplary embodiments of the present application;

FIG. 2 illustrates an exemplary flow diagram for selecting a subnet controller and at least one successor subnet controller according to the exemplary embodiments of the present application;

FIG. 3 further illustrates the process for selecting a subnet controller;

FIG. 4 further illustrates the process for selecting at least one successor subnet controller; and

FIG. 5 illustrates an exemplary flow diagram for managing a plurality of subnets with a global controller and at least one subnet controller.

### DETAILED DESCRIPTION

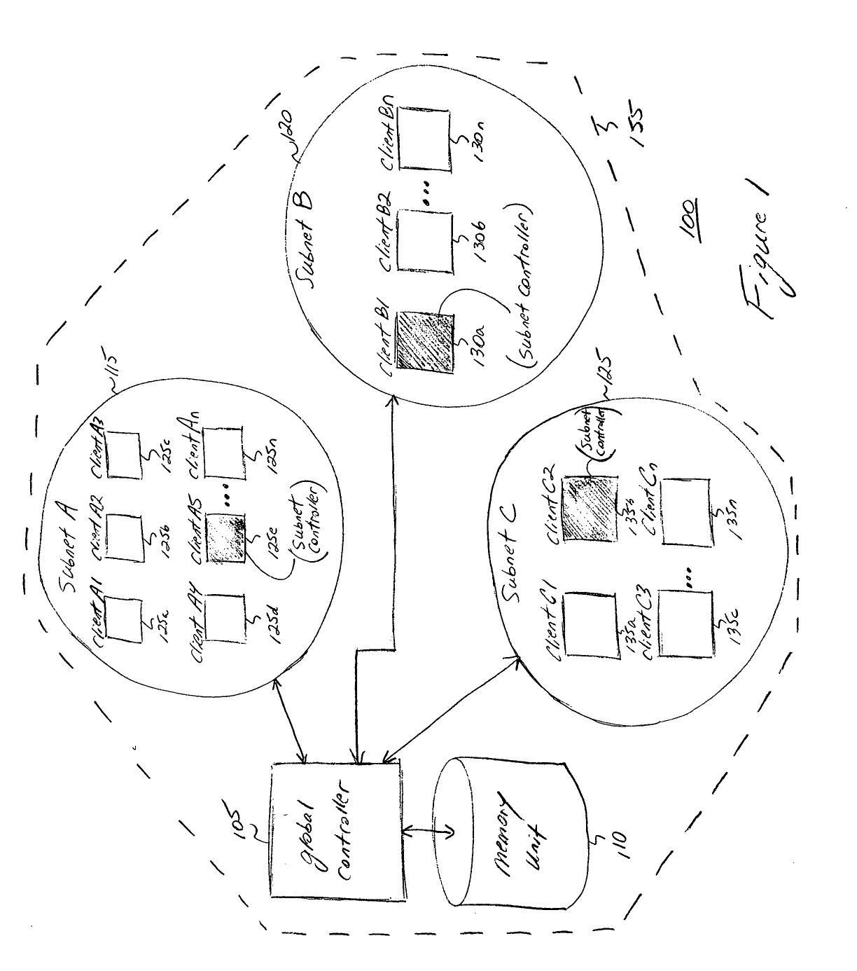

Exemplary network management system 100 is depicted in FIG. 1. Network management system 100 includes network 155 divided into at least one subnet including, for instance, subnet A 115, subnet B 120 and subnet C 125. In an exemplary embodiment, subnet A 115 includes a plurality of clients—clients A1 125a . . . An 125n, subnet B 120 includes a plurality of clients—clients B1 130a . . . Bn 130n, and subnet C 125 includes a plurality of clients—clients C1 135a . . . Cn 135n. As will be appreciated by a person having ordinary skill in the art, the illustration and description of a network being divided into three subnets is merely exemplary, as a network can be divided into more or less subnets, whereby each subnet can include one or more clients and/or other devices.

Network management system 100 also includes global controller 105 coupled to subnet A 115, subnet B 120 and subnet C 125, global controller 105 is operable for transmitting data to and receiving data from each of the respective subnets 115, 120, 125. In an exemplary embodiment, hypertext transfer protocol (“HTTP”) requests are used for communication between global controller 105 and subnets 115, 120, 125. Alternatively, other communication protocols can also be used in addition to or instead of HTTP requests such as any custom or non-custom routable network transport or protocol, such as Telnet and the secured shell referred to as SSH. As for communication amongst clients of a respective one of the subnets 115, 120, 125, including a client operable as a subnet controller, network traffic is Internet protocol based, for instance, transmission control protocol (“TCP”) and/or user datagram protocol (“UDP”). Other communication protocols for communication between global controller 105 and each subnet, and between respective clients, are equally applicable to the exemplary embodiments described and illustrated in the present application.

In an exemplary embodiment, global controller 105 is a web server operable for controlling predefined rules (referred to hereinafter as “health rules”) for managing network 155 and its plurality of subnets 115, 120, 125. For example, global controller 105 creates health rules and controls how the health rules are received by the plurality of subnets 115, 120, 125, how the health rules are viewed by the plurality of subnets 115, 120, 125, how the health rules are interpreted by the plurality of subnets 115, 120, 125 and how the health rules are reported to the plurality of subnets 115, 120, 125. Global controller 105 is operable as a data source and the exemplary functions described herein are performed by an administrative software application associated with global controller 105. The administrative software application can be a web application or a local desktop application. Global controller 105 also controls data transmitted to and from subnet A 115, subnet B 120 and subnet C 125, controls reporting functions such as listing all clients currently running a potentially harmful executable, for example, msblast.exe, and is a point of user interaction with network 155 via a web application. Global controller 105 is not limited to being operable as a web server or otherwise. Non-web based architectures and web-based architectures wherein global controller 105 is not operable as a web server can also be used for network routing and connectivity, and data store for outgoing health rules and incoming client status data.

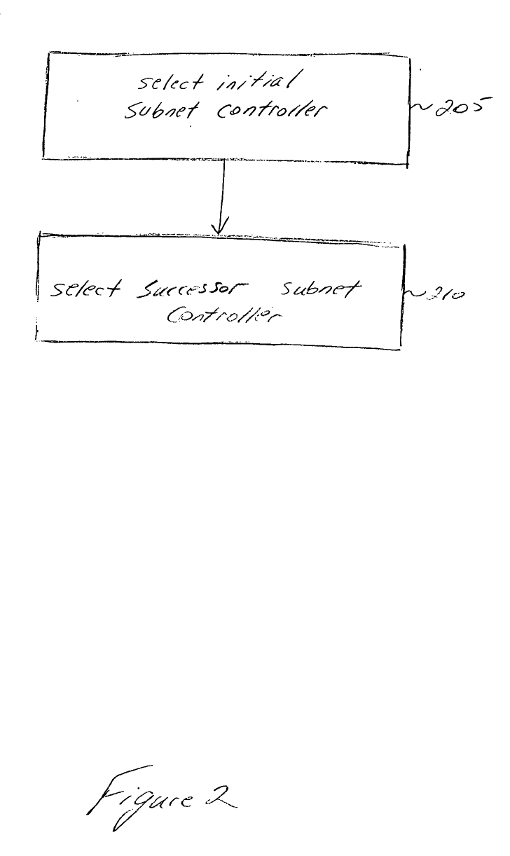

As can be seen in FIG. 1, subnet A 115 includes client A5 125e operable as a subnet controller, subnet B 120 includes client B1 130a operable as a subnet controller and subnet C 125 includes client C2 135b operable as a subnet controller. The process of selecting which client within a respective subnet is operable as a subnet controller is described in detail herein with reference to FIGS. 2 through 4. Subnet controllers 125e, 130a, 135b are operable for controlling activities on subnet A 115, subnet B 120 and subnet C 125, respectively, for example, health rule propagation, data collection and communications with global controller 105. In the present application, each client within subnet A 115 can function as a subnet controller upon being selected to serve that role. Further, a client service runs on each of the clients within subnet A 115, subnet B 120 and subnet C 125. Each client service, for instance, evaluates health rules, receives information from and reports information to a respective one of the subnet controllers 125e, 130a, 135b, and is operable for investigating nodes (other clients) that are not responding to requests from the respective one of the subnet controllers 125e, 130a, 135b.

Global controller 105 is also coupled to memory unit 110. Memory unit 110 can include various types of memory storage devices, for example, one or more databases, relational or otherwise and, therefore, is not meant to be limited to any particular type of storage device or quantity of storage devices operating alone or in combination. Memory unit 110 stores, for instance, health rule sets used for determining whether a respective client is healthy, unhealthy, managed or unmanaged.

The components of FIG. 1 may be implemented through hardware, software, and/or firmware. The components in network management system 100 are not limited to those illustrated.

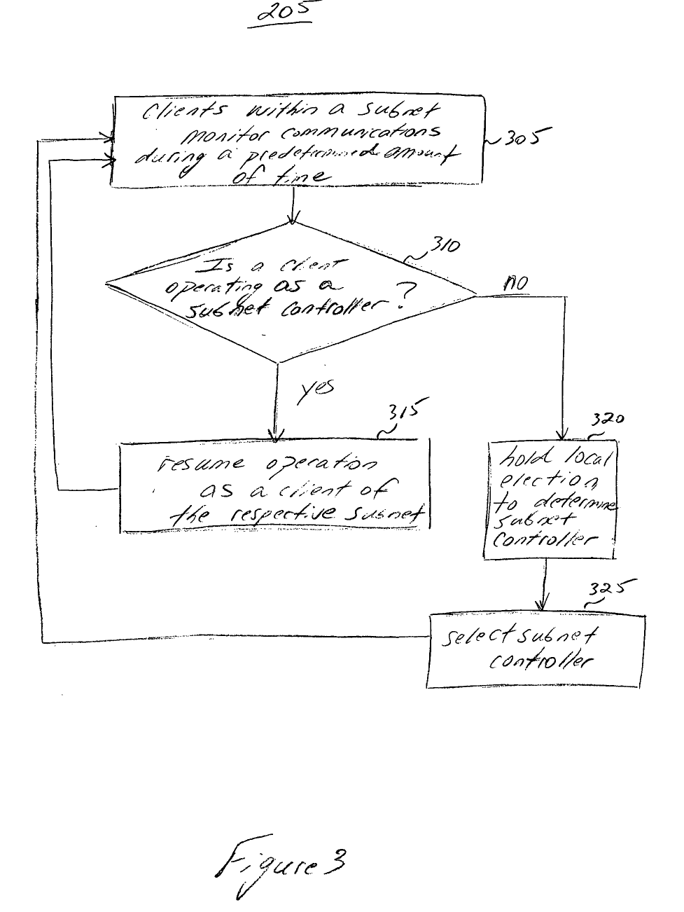

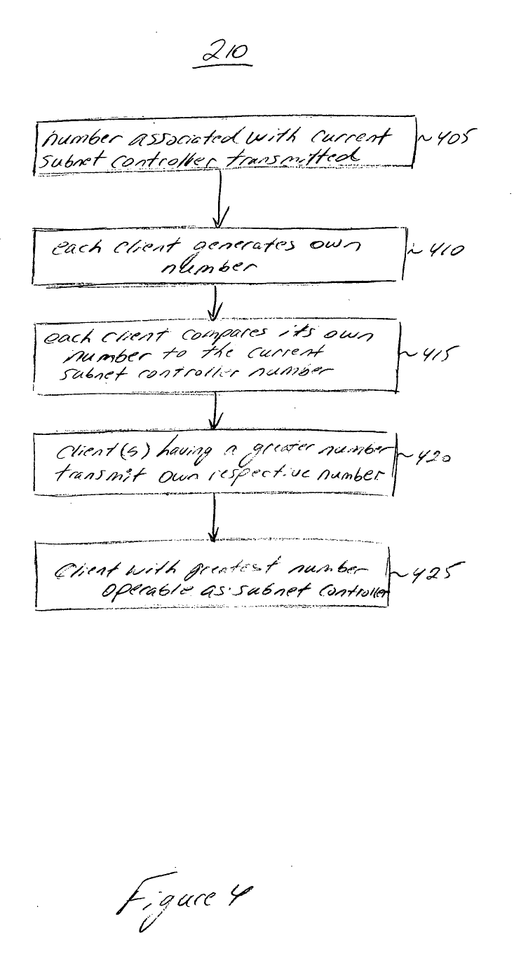

FIG. 2 illustrates an exemplary flow diagram for selecting a subnet controller and at least one successor subnet controller according to the exemplary embodiments of the present application. In 205 an initial subnet controller is selected and in 210 at least one successor subnet controller is selected within each of the subnets 115, 120, 125, described herein in more detail with reference to FIGS. 3 and 4, respectively. FIG. 3 illustrates in more detail the process of selecting an initial subnet controller. In an exemplary embodiment of the present application, a subnet controller for each of the plurality of subnets 115, 120 and 125 is selected through a process by which each of the clients within the respective one of the plurality of subnets 115, 120 and 125 participates in a local election to determine that subnet controller. Specifically, for example, each of clients A1 125a . . . An 125n monitors communications between each other during a predetermined interval to determine whether one of clients A1 . . . 125a . . . An 125n is acting as a subnet controller for subnet A 115, in 305 and 310. If it is determined that at least one of clients A1 125a . . . An 125n has not received data from another client within subnet A 115 indicative of that other client operating as a subnet controller during the predetermined interval, then clients A1 125a . . . An 125n hold a local election to determine which of clients A1 125a . . . An 125n will be selected as the subnet controller, in 320. As will be appreciated by a person having ordinary skill in the art, election processes are well known in the art and therefore are not described in detail herein. For example, an election process as set forth at www.elet.polimi.it/upload/fornacia/didattica/labsw0304/2004ElectionAlgorithms.pdf can be utilized for the exemplary embodiments of the present application. Once the local election process has concluded, the subnet controller, for example, client A5 125e, is selected, in 325. The above-described process is repeated every predetermined interval in order to determine whether one of clients A1 . . . 125a . . . An 125n is acting as a subnet controller for subnet A 115, for instance, by monitoring whether communication is originating from a client indicative of that client operating as a subnet controller.

In an exemplary embodiment, global controller 105 does not play a role in determining which client is selected as an initial subnet controller or as a successive subnet controller. A local election process the same as or similar to the local election process performed for subnet A 115 is performed for subnet B 120 and subnet C 125 and therefore a detailed description is not provided herein for those subnets.

If it is determined that at least one of clients A1 125a . . . An 125n has received data from another client within subnet A 115 indicative of that other client operating as a subnet controller during the predetermined interval, then each of the clients not operating as a subnet controller resume operations and therefore do not hold a local election, in 315. For instance, in order to determine whether one of clients A1 . . . 125a . . . An 125n is acting as a subnet controller, a determination is made whether a client on the respective subnet receives a request for status from a subnet controller within the predetermined interval, for example, within X time cycles, and if so, a local election process will not begin.

FIG. 4 illustrates the process for selecting at least one successor subnet controller to replace an initial subnet controller, for instance, to replace subnet controller 125e within subnet A 115. In the present application, a successor subnet controller is selected when a current subnet controller, for instance, an initial subnet controller, will be powered down, its processor speed has decreased below a predetermined threshold, its memory capacity has decreased below a predetermined capacity, the subnet controller is improperly operating and a user logs into the current subnet controller.

In order to replace a current subnet controller such as subnet controller 125e, subnet controller 125e initiates the process by transmiting a previously determined number n, referred to herein as a bully number, to each of the other clients within subnet A 115, in 405. In an exemplary embodiment, bully number n is determined by the respective current subnet controller as follows. Subnet controller 125e processes a software application stored in a memory unit associated with subnet controller 125e that is operable as an election algorithm. The election algorithm evaluates various criteria associated with subnet controller 125e, such as processor speed, whether a user logged into the client, how may users are connected to the client, memory size, network connection speed, central processing unit utilization and number of processors. The above-enumerated criteria are merely exemplary and are not intended to limit the scope of the present application. Based on the results of these inquires by subnet controller 125e, the election algorithm generates a bully number n. Bully number n is received by each of the other clients within subnet A 115 and each of these clients generates its respective number n using an election algorithm stored locally at that client, for instance, the same election algorithm with the same election criteria as used by the current subnet controller, in 410. Each client can generate its bully number n before or after receiving the number n associated with the current subnet controller. Each client within subnet A 115 then compares its respective bully number n with bully number n associated with current subnet controller 125e, 415. Those client(s) having a greater bully number n than the bully number n associated with current subnet controller 125e transmit its (their) respective bully numbers to the other clients within subnet A 115, in 420. This process is repeated until the client amongst clients A1 125a . . . An 125n having the greatest bully number n is determined, in 425. That client is then operable as the successor subnet controller within subnet A 115. In an exemplary embodiment, if the other clients within subnet A 115 do not have a bully number n greater than the bully number n associated with current subnet controller 125e, then the other clients do not respond to election requests. The same process is performed for subnet B 120 and subnet C 125 when a successor subnet controller needs to be selected for current subnet controller 130a and current subnet controller 135b, respectively. In the event that two or more clients have the same bully number n, the two or more clients will operate as the subnet controller. As a result, each of these clients will note that it is not the only client, for instance, within subnet A 115, operating as a subnet controller and therefore will negotiate with the other clients to determine which of them will remain as subnet controller 125e. For example, negotiation occurs by each of the two or more clients generating a random number and the client with the highest generated number will operate as the subnet controller.

Instead of subnet controller 135b transmitting its current bully number n, current subnet controller 135b can call for an election using a bully number of zero which would result in automatic loss for current subnet controller 135b to any client in subnet C 125 since the other generated bully numbers are, for instance, positive integers. Alternatively, current subnet controller 135b could call an election at an incrementally smaller bully number than subnet controller's 135b bully number n and if a client responds with a higher bully number, then that client will become the successor subnet controller.

In another exemplary embodiment of the present application, each of the current subnet controllers within subnet A 115, subnet B 120 and subnet C 125 stores data identifying the client within its respective subnet having the highest bully number n or a group of clients having the highest bully numbers. For instance, subnet controller 135b within subnet C 125 stores a data list or the like in a memory unit associated therewith identifying five other clients within subnet C 125 having the highest bully numbers n, as previously determined by an election algorithm running locally on each of those clients. Subnet controller 135b received these numbers from the other clients during an interval of standard communication between clients and subnet controller 135b, as described herein. As a result, when a successor subnet controller needs to be selected, current subnet controller 135b selects the client associated with the greatest bully number n if that client is available, selects the client with the next greatest bully number n if the previous client was not available, etcetera. In an exemplary embodiment, current subnet controller 135b determines that a client is available by determining whether that client responded to data transmitted to that client. If all the clients identified in the data list or the like are not available, then an election process is performed as described above with reference to FIG. 4. In particular, subnet controller 135b can transmit its current bully number n, a bully number n of zero or an incrementally smaller bully number. Alternatively, if all the clients in the data list or the like are not available, then current subnet controller 135b shuts down and an election will ensue after a period of time has elapsed since the clients within subnet C 125 will note that there is no assigned subnet controller for that subnet, as described herein with reference to FIG. 3.

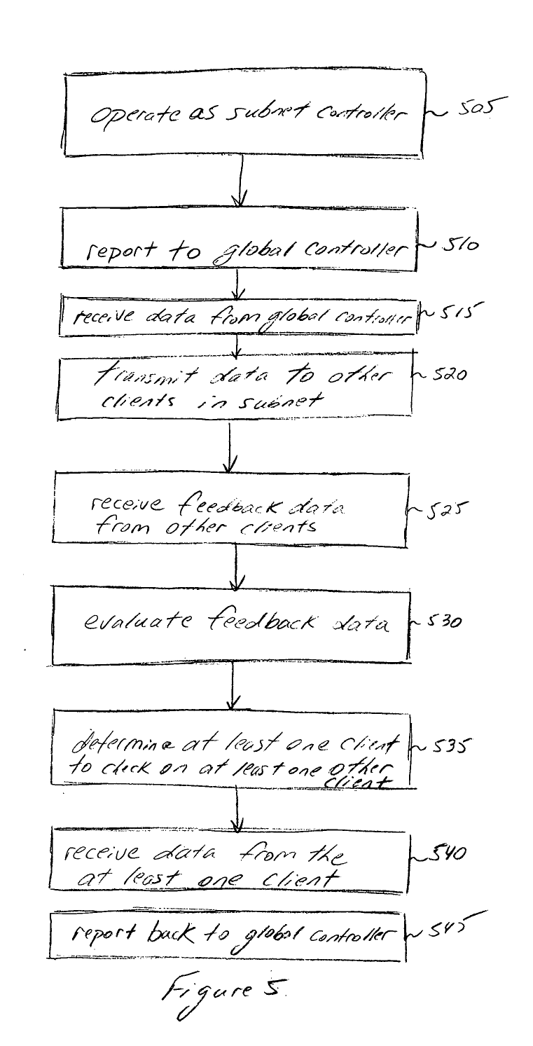

FIG. 5 illustrates an exemplary flow diagram for managing a plurality of subnets with a global controller and at least one subnet controller. Subnet A 115 includes client A5 125e, subnet B 120 includes client B1 130a and subnet C 125 includes client C2 135b, each of these clients operating as a subnet controller for its respective subnet, in 505. Periodically, for instance, after the expiration of a predetermined amount of time, subnet controller 125e, subnet controller 130a and subnet controller 135b report to global controller 105, in 510. Thereafter, subnet controller 125e, subnet controller 130a and subnet controller 135b receive data from global controller 105, including, for example, any new health rules for managing subnet A 115, subnet B 120 and subnet C 125, respectively, and while global controller 105 can dictate the interval for health checks in an exemplary embodiment each respective subnet controller is responsible for keeping this interval and hence does not receive instructions to do so each time, in 515.

The following are exemplary health rules and are not intended on limiting the scope of the present application in any way. A health rule may state that clients need to be checked to determine whether the program msblast.exe is running on each respective client and if it is running on one or more clients, that client(s) is determined to be unhealthy. Likewise, another health rule may state that clients need to be checked to determine whether a virus definition file is more that a predetermined number of days old and if so that client(s) is determined to be unhealthy. Health rules can also be more or less specific, for instance, determining whether a client is running a Microsoft® SQL server and determining whether a particular dynamic link library is not a certain version and if it is that version, that client(s) is determined to be unhealthy.

In compliance with any new or existing health rules and instructions, subnet controller 125e, subnet controller 130a and subnet controller 135b transmit data to each client within subnet A 115, subnet B 120 and subnet C 125, respectively, in order to determine the health of these clients including whether each client is managed or unmanaged, in 520. Each client has a rule parser that understands the health rules and evaluates each health rule. The health rules are updated as a result of subnet controllers 125e, 130a, 135b asking for a “health check” and along with the request is a time/date stamp of the last health rule update. If a client has one or more out-of-date (old) health rules that client will request a new health rule set from the respective one of subnet controllers 125e, 130a, 135b. The questions and/or responses can be secured and encrypted in order to prevent improper clients from reporting egregious information.

Subnet controller 125e, subnet controller 130a and subnet controller 135b store data indicating the number of clients within their respective subnets and hence the number of clients that should respond to the health related question or questions. For instance, subnet controllers 130a, 135b know all the valid addresses of clients on their respective subnet that should respond because this data is derived by a subnet mask and subnet address when using, for example, the communication protocol TCP/IP. In 525, subnet controller 125e, subnet controller 130a and subnet controller 135b receive feedback data from one or more clients within their respective subnet. The feedback data includes, for instance, responses to the transmitted question or questions. In an exemplary embodiment, the responses to the transmitted question or questions is either true or false. As will be appreciated by a person having ordinary skill in the art, other responses could be utilized, such as yes/no, pass/fail or the like, or more detailed responses.

Each subnet controller 125e, 130a, 135b evaluates the feedback data pertaining to those responsive clients within its subnet to determine whether each client is managed or unmanaged and whether each client has indicated it is healthy or not healthy, in 530. More particularly, the feedback data will indicate whether each client is healthy because as described herein, each client utilizes the health rules to determine locally whether that respective client is healthy. For instance, a client is determined to be healthy by a subnet controller if the client is determined to be active in a respective subnet and that client reported that it passed all the health rules that have been established. On the other hand, a client is determined to be unhealthy if the client is determined to be active, but reported that it failed one or more of the health rules that have been established. Further, subnet controllers 125e, 130a, 135b know that a client is managed by virtue of that client responding to a health check query. Any client that is active on network 155, for instance, the client returns a ping, but does not respond to the respective subnet controller's health check query is determined to be un-managed. In the present application, an active client is one that is operational and connected to network 155.

In an exemplary embodiment, for those clients within a respective subnet that did not respond to the data transmitted by subnet controller 125e, subnet controller 125e delegates further investigation to at least one other client with subnet A 115. In particular, subnet controller 125e selects at least one of the responsive clients within subnet A 115 to check on the status of at least one of the non-responsive known clients within subnet A 115, if it was determined by subnet controller 125e that at least one of the known clients within subnet A 115 was non-responsive, in 535. In an exemplary embodiment, subnet controller 125e determines which of the responsive clients to conduct further investigation by transmitting at least one question to each of the responsive clients within subnet A 115 and whichever client responds first is delegated the task of checking on the status of at least one non-responsive client within that subnet.

In an alternative embodiment, the subnet controller, for example, subnet controller 125e, maintains a queue of addresses that need to be researched, the subnet controller then sends a request to all clients within that subnet, and as each client connects tasks are distributed in batches of a predetermined number on a first come, first serve basis.

The delegated client or clients selected by subnet controller 125e is instructed by subnet controller 125e to ping particular non-responding clients within subnet A 115. If the non-responsive client or clients do not respond to the ping, the delegated client(s) determine that the non-responsive client or clients is not located at the respective uniform resource locator (“URL”) address. If the non-responsive client or clients do, however, respond to the ping, then the delegated client(s) transmits at least one question to the now responsive client or clients. Depending on the answer(s) to the question(s), the delegated client or clients determine whether the client or clients are managed, unmanaged, healthy or unhealthy as previously described herein with respect to 520 through 530 of FIG. 5.

The same process is followed for subnet B 120 and subnet C 125, if it was determined by subnet controller 130a and subnet controller 135b, respectively, that at least one of the known clients within subnet B 120 and subnet C 125, respectively, were non-responsive. Instead of or in addition to using a ping, specific IP ports on remote clients can be probed.

Once the delegated client or clients within subnets 115, 120, 125 conclude their investigation, data indicating the results of the investigation is transmitted to and received by subnet controllers 125e, 130a, 135b, respectively, in 540. Thereafter, subnet controllers 125e, 130a, 135b report the results back to global controller 105, in 545.

According to the exemplary embodiments described and illustrated in the present application, network management system 100 determines the current active clients on network 100 and their physical location, regardless whether a respective client is managed or unmanaged, determines file system information such as the existence of a particular file, determines registry information such as the existence of a particular key or registry and determines service information such as whether an anti-virus application is running on a respective client. In the present application, specific information can be determined for managed clients. For unmanaged clients, the operating system that is running and not specific information can be determined.

Further, the following exemplary situations are identified and handled by network management system 100 according to the exemplary embodiments of the present application: an application fails due to a software rollout gone astray so users are identified that are having problems; a new virus hits the Internet so anti-virus protection and patch level are verified and unprotected clients are removed from network 155 before the virus enters network 155; and a new virus enters network 155 so its location and how fast it is spreading can be determined, and entire subnets, for instance, subnets 115, 120, 125 can be quarantined. Also, network management system 100 determines when an unmanaged client is plugged into network 155 according to the exemplary embodiments set forth herein. In the present application, clients within a respective subnet know a new client has logged into network 155 when a new cycle begins, that new client will either be managed and start participating in the subnet or the new client will be unmanaged and detected by a health scan and then reported. Each of these exemplary situations are handled based on the health rules that are populated in global controller 105 to know and search for specific information in the form of files and registry entries.

The embodiments described above are illustrative examples of the present application and it should not be construed that the present application is limited to these particular embodiments. Various changes and modifications may be effected by one skilled in the art without departing from the spirit or scope of the invention as defined in the appended claims.

1. A method for managing a network, the network comprising:
partitioning the network into at least one subnet, the at least one subnet including a plurality of clients;
selecting one of the plurality of clients to be operable as a subnet controller; and
selecting another of the plurality of clients to be operable as a successor subnet controller,
the subnet controller and the successor subnet controller being operable for determining health of the plurality of clients within the at least one subnet.

2. The method as set forth in claim 1, wherein
selecting the one of the plurality of clients to be operable as the subnet controller includes
monitoring communications between each of the plurality of clients for determining whether one of the plurality of clients is operating as the subnet controller, and
performing a local election amongst the plurality of clients within the at least one subnet if it is determined that one of the plurality of clients is not operating as the subnet controller.

3. The method as set forth in claim 2, wherein
monitoring communications includes
monitoring communications for a first predetermined period of time for determining whether one of the plurality of clients is operating as the subnet controller, and
repeating the monitoring after expiration of a second predetermined period of time.

4. The method as set forth in claim 3, wherein
monitoring communications for the first predetermined period of time includes
determining whether communication is originating from one of the plurality of clients indicative of the one of the plurality of clients operating as the subnet controller.

5. The method as set forth in claim 4, wherein
determining whether communication is originating from the one of the plurality of clients includes
determining whether another of the plurality of clients receives a request for status from the one of the plurality of clients.

6. The method as set forth in claim 1, wherein
the other of the plurality of clients is selected as the successor subnet controller when one of the subnet controller will be powered down, processor speed of the subnet controller has decreased below a predetermined threshold, memory capacity of the subnet controller has decreased below a predetermined capacity, the subnet controller is improperly operating and a user logs into the subnet controller.

7. The method as set forth in claim 1, wherein
selecting another of the plurality of clients to be operable as the successor subnet controller includes
generating by the subnet controller a number,
transmitting by the subnet controller the number to each of the other plurality of clients,
generating by the each of the other plurality of clients a respective number,
comparing by the each of the other plurality of clients the respective number with the number associated with the subnet controller to determine if the respective number is greater than the number,
transmitting by at least one of the other plurality of clients its respective number to the other of the plurality of clients if it is determined that its respective number is greater than the number, and
repeating until one of the plurality of clients determines that its respective number is greater than the respective number of each of the other plurality of clients.

8. The method as set forth in claim 7, wherein
generating the number includes using a software application stored in a memory unit associated with the subnet controller to evaluate at least one of the following criteria associated with the subnet controller: processor speed, whether a user is logged into the subnet controller, a number of users connected to the subnet controller, a memory size, a network connection speed, central processing utilization and a number of processors.

9. The method as set forth in claim 7, wherein
generating the respective number for each of the other plurality of clients includes using a software application stored in a memory unit to evaluate at least one of the following criteria: processor speed, whether a user is logged in, a number of connected users, a memory size, a network connection speed, central processing utilization and a number of processors.

10. The method as set forth in claim 1, wherein
selecting another of the plurality of clients to be operable as the successor subnet controller includes
the subnet controller maintaining a list of data identifying one or more of the plurality of clients having a number greater than a number associated with the subnet controller, each number being determined by evaluating at least one of the following criteria associated with the subnet controller and associated with the one or more of the plurality of clients: processor speed, whether a user is logged in, a number of connected users, a memory size, a network connection speed, central processing utilization and a number of processors,
determining the client identified in the list having the greatest number that is available for operating as the successor subnet controller, and
selecting the client to be operable as the successor subnet controller, if at least one client is available.

11. The method as set forth in claim 10, wherein
determining the client identified in the list having the greatest number that is available for operating as the successor subnet controller includes
determining whether the client identified in the list responded to data transmitted to the client from the subnet controller.

12. The method as set forth in claim 10, further comprising:
performing a local election within the at least one subnet if at least one client in the list is not available for operating as the successor subnet controller to determine the successor subnet controller.

13. The method as set forth in claim 1, wherein determining the health of the plurality of clients includes
implementing at least one health rule by the subnet controller and the successor subnet controller, the at least one health rule being stored locally at the subnet controller and the successor subnet controller.

14. The method as set forth in claim 13, wherein
the at least one health rule includes at least one of
determining whether a particular application is running on each of the plurality of clients,
determining a date of a particular virus definition file on each of the plurality of clients and whether the file is greater than a predetermined number of days,
determining whether each of the plurality of clients is running a particular server, and
determining whether a particular library is a particular version on each of the plurality of clients.

15. A method for managing a subnet having a plurality of clients, the method comprising:
operating as a subnet controller, the subnet controller being one of the plurality of clients;
reporting to a global controller;
receiving data from the global controller;
transmitting data to the plurality of clients within the subnet;
receiving feedback data from at least one client of the plurality of clients;
evaluating the feedback data for determining health of the at least one client; and
reporting to the global controller data regarding the health of the at least one client.

16. The method as set forth in claim 15, further comprising:
determining a client of the plurality of clients to check the health of the clients within the subnet that did not provide the feedback data to the subnet controller; and
receiving data from the client regarding the health of the clients that did not provide the feedback data.

17. The method as set forth in claim 15, wherein
the global controller is located outside the subnet and
reporting to the global controller includes
reporting to the global controller after expiration of a predetermined amount of time.

18. The method as set forth in claim 15, wherein
receiving data from the global controller includes
receiving at least one health rule for the subnet controller to manage the subnet.

19. The method as set forth in claim 18, wherein
the at least one health rule includes at least one of
determining whether a particular application is running on each of the plurality of clients,
determining a date of a particular virus definition file on each of the plurality of clients and whether the file is greater than a predetermined number of days,
determining whether each of the plurality of clients is running a particular server, and
determining whether a particular library is a particular version on each of the plurality of clients.

20. The method as set forth in claim 15, wherein
the global controller dictates an interval of time during which the subnet controller checks the health of the plurality of clients, data indicating the interval of the time included within the data received from the global controller.

21. The method as set forth in claim 15, wherein
each of the plurality of clients has a rule parser, and
transmitting data to the plurality of clients within the subnet includes
transmitting at least one health rule for each of the plurality of clients to determine compliance with the at least one health rule using the respective rule parser, the at least one health rule being at least one question.

22. The method as set forth in claim 21, wherein
the subnet controller stores address data identifying each of the plurality of clients within the subnet for determining a quantity of and identity of clients that should respond to the at least one question.

23. The method as set forth in claim 22, wherein
receiving feedback data includes
receiving at least one response to the at least one respective question.

24. The method as set forth in claim 23, wherein
the at least one response is one of true or false, yes or no, and pass or fail.

25. The method as set forth in claim 23, wherein
evaluating the feedback data for determining the health of the at least one client includes
determining whether the at least one client is active in the subnet and whether the at least one response indicates compliance with the at least one corresponding health rule.

26. The method as set forth in claim 25, wherein
if the at least one client is determined to be active in the subnet and the at least one response indicates compliance with the at least one corresponding health rule, then a determination is made that the at least one client is healthy.

27. The method as set forth in claim 25, wherein
if the at least one client is determined to be active in the subnet and the at least one client did not transmit a response to the at least one question, then a determination is made that the at least one client is un-managed.

28. The method as set forth in claim 16, wherein
determining the client of the plurality of clients to check the health of the clients within the subnet that did not provide the feedback data to the subnet controller includes
transmitting at least one question to each of the clients of the plurality of clients that did provide the feedback data to the subnet controller,
determining which of the clients that did provide the feedback data to the subnet controller responds first to the at least one question, and
delegating a task of checking on the health of the clients within the subnet that did not provide the feedback data to the client that responds first, the task being to check on the health of the clients.

29. The method as set forth in claim 28, wherein
the client that responded first checks on the health of the clients within the subnet that did not provide the feedback data by pinging the clients that did not provide the feedback data and transmitting at least one question to at least one of the clients that respond to the pinging for determining the health of the at least one of the clients.

30. The method as set forth in claim 15, further comprising:
determining a plurality of clients to check the health of the clients within the subnet that did not provide the feedback data to the subnet controller; and
receiving data from the plurality of clients regarding the health of the clients that did not provide the feedback data.

31. The method as set forth in claim 30, wherein
determining the plurality of clients to check the health of the clients within the subnet that did not provide the feedback data to the subnet controller includes
maintaining a queue of addresses of the clients within the subnet that did not provide the feedback data to the subnet controller,
transmitting a request to each of the clients that did provide the feedback data to check on the health of the clients within the subnet that did not provide the feedback data to the subnet controller, and
delegating tasks in batches to each of the plurality of clients in the order that each client responds to the request, each task being to check on the health of a client located at one of the addresses.

32. The method as set forth in claim 31, wherein
the clients check on the health of the clients within the subnet that did not provide the feedback data by pinging the clients that did not provide the feedback data and transmitting at least one question to at least one of the clients that respond to the pinging for determining the health of the at least one of the clients.

33. The method as set forth in claim 28, further comprising:
receiving data from the client that responded first indicating the health of the clients within the subnet that did not provide the feedback data.

34. The method as set forth in claim 31, further comprising:
receiving data from the plurality of clients indicating the health of the clients within the subnet that did not provide the feedback data.

35. A system for managing a network including at least one subnet, the system comprising:
a plurality of clients located within the at least one subnet, one client of the plurality of clients operable as a subnet controller for managing the at least one subnet, each of the plurality of clients having an election algorithm for selecting the one client within each of the plurality of subnets operable as the subnet controller; and
a global controller coupled to the at least one subnet, the global controller transmitting at least one health rule to the one client within each of the plurality of subnets operable as the subnet controller, wherein the one client within the at least one subnet operable as the subnet controller delegates to at least one of the other clients within the at least one subnet monitoring of the plurality of clients within the at least one subnet according to the at least one health rule.
